(19) United States
(12) Patent Application Publication
(10) Pub. No.: US 2012/0148219 A1
(43) Pub. Date: Jun. 14, 2012

(54) OVEN FOR FOOD USE AND METHOD FOR BAKING A CEREAL-BASED DOUGH

(75) Inventors: Alain Le Bail, Nantes (FR); Vanessa Jury, La Chapelle sur Erdre (FR); Tzvetelin Dessev, Nantes (FR)

(73) Assignee: CENTRE NATIONAL DE LA RECHERCHE SCIENTIFIQUE (CNRS)

(21) Appl. No.: 13/383,500

(22) PCT Filed: Jul. 15, 2010
(86) PCT No.: PCT/EP10/60195

§ 371 Date: Jan. 11, 2012

(30) Foreign Application Priority Data
Jul. 16, 2009 (FR) 0954944

(51) Int. Cl. A21B 2/00

(52) U.S. Cl. 392/416

(57) ABSTRACT

The present invention relates particularly to an oven (1) for food use, for cooking a cereal-based dough, particularly a fermented dough, which includes a thermally insulated chamber (10) in which the base comprises of a bottom (2) made from a refractory material, said oven also containing a means (3) for heating the bottom (2) and said chamber (10). Said oven is essentially characterised in that said heating means comprises a means emitting energy in the form of electromagnetic radiation in the infrared band, arranged in the top portion of the chamber (10) and facing the bottom (2), and in that said oven is devoid of any other means for heating said bottom.

The present invention relates to an oven for food use, for baking cereal-based dough, particularly fermented dough such as bread dough.

It also concerns a method for baking a cereal-based food dough.

It is well known that the baking of cereal products such as bread dough consumes much energy.

For example, the baking of bread requires about 2 to 5 Mjoules per kilogram of bread to be baked according to bibliographic sources.

By way of indication, this energy is two to three times higher than required for the same weight of a food product in preserved form.

One traditional method for baking bread makes use of an electric oven provided with a floor. The floor is a refractory stone arranged in the lower part of an oven and intended to receive the loaves throughout baking.

This oven is formed of a thermally insulated chamber which comprises a floor in refractory material on which the cereal dough is deposited in the form of dough pieces for preparing loaves.

Said oven is most often equipped with electric resistances placed inside the chamber in the vicinity of the roof thereof.

Also, this oven is provided with additional resistances which are placed underneath the floor and whose function is to carry out pre-heating. These resistances are therefore placed between the floor and a wall forming the base of the oven.

The energy stored by the constituent refractory material of the floor (stone, special cement, etc) very largely contributes towards baking of the dough.

This method generally gives satisfaction, but it is obvious that a good part of the delivered electric energy is wasted and is particularly absorbed by the walls of the chamber forming the oven without positively contributing towards baking of the dough. This is particularly true with respect to the electric resistances positioned underneath the oven floor of which part of the emitted energy is absorbed by the oven wall.

It is also known that a large part of the energy demand for baking bread is required during the oven pre-heating phase i.e. before the dough pieces are placed inside the oven.

Later, in the course of baking, the energy demand is smaller since the temperature required for raising the dough is equal to or lower than the temperature of the oven after this pre-heating.

With the traditional method described above it is easily understood that loss of energy occurs during the process.

An oven for domestic use is described in FR 2 636 410 in which it is proposed to solve the problem of improved cleaning of the walls of the inner cavity of the oven. This is solved by the fact that a material is used which has a thermal expansion coefficient close to zero. As specified in this document, the oven comprises a control and regulation panel, heating elements both at floor level and at the grill associated with the roof, as well as other various conventional elements.

In GB 2 281 653 there is provided an oven devoid of a floor. Its heating means, consisting of lamps, are arranged in the upper part of the oven cavity but also at its side walls.

It is the objective of the present invention to overcome the above-mentioned disadvantages by providing an oven for food use for baking cereal-based dough, which allows notable energy savings whilst allowing fully satisfactory baking of the dough.

The present invention also sets out to provide a method for baking food dough also allowing these energy saving objectives to be achieved.

Therefore, according to a first aspect of the invention, it concerns an oven for food use for baking cereal-based dough in particular fermented dough, which comprises a thermally insulated chamber whose base is formed of a floor in refractory material and which contains means for heating the floor and said chamber.

According to the invention, said heating means are formed of means emitting energy mostly in the form of electromagnetic radiation in the infrared range, arranged in the upper part of the chamber and oriented in the direction of the floor, and in that it is devoid of any other means for heating said floor.

In other words, the floor is not provided with nearby heating means. As will be seen below the only heating means, which preferably comprise lamps, allow pre-heating of the floor then heating of the upper part of the dough pieces during baking. These lamps comprise a filament brought to high temperature which emits energy in the form of electromagnetic radiation whose wavelength covers a large part of the spectrum of visible wavelengths for the human eye. For the non-visible part of this spectrum, the term radiation or energy of short or mid-infrared type is used.

By means of this arrangement, it was realized that it is possible to carry out baking of a dough for example to obtain bread, making large energy savings whilst obtaining a baked product that is fully satisfactory, having similar characteristic to bread baked in a traditional oven equipped with two heating systems (floor and roof).

According to other advantageous characteristics of this oven:
said heating means are formed of lamps;
it comprises means for controlling the power of said heating means;
said power-controlling means comprise at least one temperature sensor placed in said floor;
it comprises at least two sensors and these sensors, taking into account the thickness of said floor, each occupy a different position relative to the upper surface thereof;
it comprises means for modulating the power of the heating means;
said means are capable respectively of reducing and increasing the power of all the heating means;
said means, in order to reduce the power of the heating means, are capable of causing the alternate switching-on/switching-off of a first part of the heating means, in synchronization with the switching-off/switching-on of a second part of the heating means;
at full power said heating means emit radiation of wavelength in the short infrared range (0.8 to 2 μm) or mid-infrared (2 to 4 μm);
the floor is of dark shade to promote absorption of the infrared radiation close to the wavelength of the visible range (short infrared);
it comprises means for generating steam, and the controlled injection thereof into said chamber, and optionally for recovering non-absorbed steam;
this oven is equipped with a system for measuring the electric power consumed by each lamp individually in order to detect whether a lamp has an operating anomaly and must be replaced;
the electric connections of said lamps lie outside the chamber;
said heating means are formed of burners equipped with metal foam or refractory ceramic and supplied with gas fuel such as natural gas or liquid petroleum gas.

As indicated above, the present invention also relates to a method for baking a cereal-based food dough, in particular a fermented dough, in an oven which comprises a thermally insulated chamber whose base is formed of a floor in refractory material and which contains means for heating the floor and said chamber, which are formed of a set of heating means such as lamps emitting in the infrared, arranged in the upper part of the chamber and oriented in the direction of the floor, with the exclusion of any other means for heating said floor,

characterized by the fact that it comprises implementing the following steps:

a/ preheating the, empty, oven using said heating means;

b/ placing said dough in this oven leaving it to rest on the floor;

c/ reducing or zeroing the power of said heating means and continuing the baking until the desired degree of baking and/or baking time are reached;

d/ during the baking phase, optionally adding a certain amount of steam to promote expansion of the bread during baking (expansion of the fermented dough in the oven).

In some operating modes, it can therefore be contemplated to conduct baking with said heating means having a power equal to zero (no power) by providing the heat needed for baking solely through the energy stored in the floor.

According to particular embodiments of this method:
the desired duration of baking is measured using the measurement of a temperature probe arranged in the dough or in the floor, or using thermometric means which remotely measure the surface temperature of the dough while baking via infrared radiation;
the oven pre-heating time is measured using the measurement given by a temperature probe arranged in the floor, given by thermometric means remotely communicating via infrared radiation (contactless infrared thermometer) and allowing the remote measurement of the temperature of the upper or lower side of the floor, or by a flowmeter installed in the floor;
at step c/ the power of all the lamps is reduced;
at step c/ alternate switching-on/switching-off of a first part of the lamps is caused, synchronized with the switching-off/switching-on of a second part of the lamps;
completion of baking is controlled using video means capable of assessing the extent of coloring of the dough crust, so as to act on the power of said heating means and decide on completion of baking;
the ratio between the energy returned by the floor during baking and the energy required for baking the dough pieces is between about 2 and 3, without taking into account the energy related to water evaporation (drying of the crust).

Other characteristics and advantages of the present invention will become apparent on reading the detailed description given below of one particular embodiment.

This description is given with reference to the appended drawings in which:

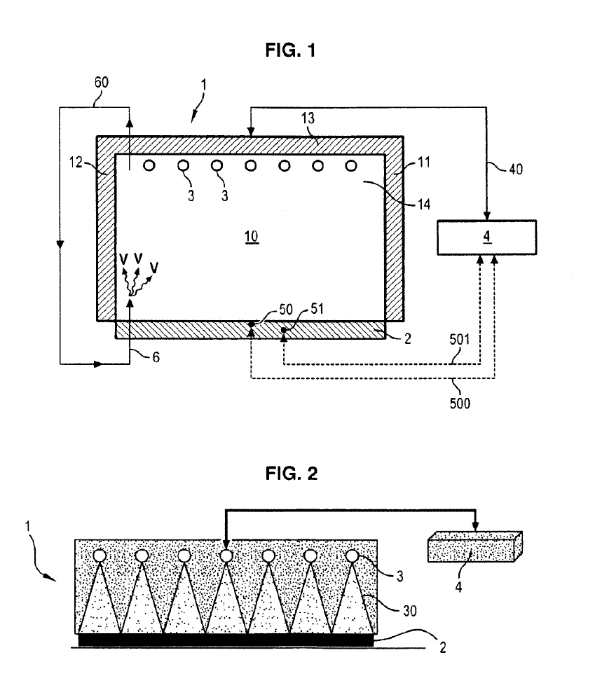

FIG. 1 is a schematic view of an oven conforming to the invention, along a cross-sectional and vertical section plan.

FIGS. 2 to 4 are very schematic views of this oven intended to illustrate the oven pre-heating steps and baking of the dough pieces.

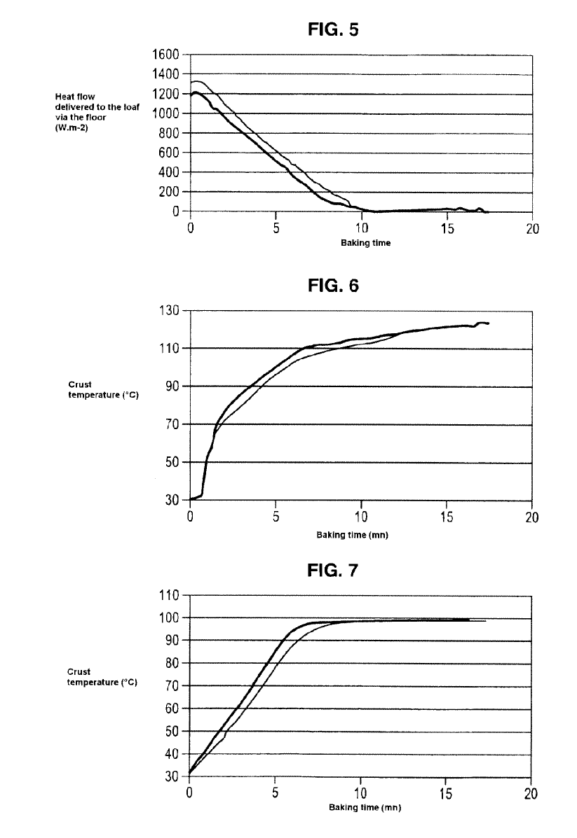

FIGS. 5 to 7 are curves evaluating different baking parameters as a function of time, with an oven according to the invention and a conventional oven used as control.

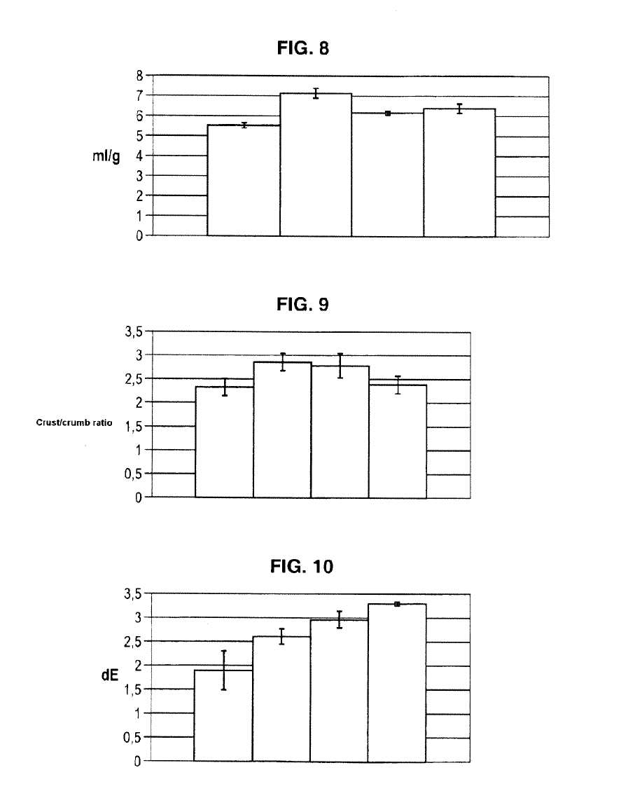

FIGS. 8 to 10 are graphs giving the different baking test results, for baking according to the invention and with a control oven.

The oven according to the invention, such as illustrated in appended FIG. 1, has a structure that is generally known per se.

It is formed of a thermally insulated chamber 10 which is laterally delimited by walls 11, 12 and 14 and at its top part by a roof 13.

All these walls are made in a metal material which allows containing of the humidity of the oven, and have an outer thermal insulation, or they are in refractory material such as brick.

Its base is formed of a floor 2 also in refractory material for example of thickness of about 2 cm.

In one preferred embodiment, the upper surface of the floor is of dark color so as to absorb maximum radiation emitted during heating of the oven.

The oven 1 is provided with means for heating the floor and the chamber 10.

These heating means emit energy that is mostly in the form of electromagnetic radiation. They are formed of a set of lamps 3 which emit in the infrared and are arranged in the upper part of the chamber 10. They extend close to the roof 13 and are oriented in the direction of the floor 2.

By way of indication, for a roof surface of one square meter, 8 to 12 lamps are used that are regularly spaced. For example, lamps are used which each have a maximum power of 2500 W.

In one preferred embodiment, these infrared lamps emit radiation whose wavelength is equal to about 1 μm to 1.5 μm when used at full power.

It will be noted that, in conformity with the invention, these heating means formed of lamps are the only means used in the oven and therefore the oven is devoid of any other means for heating the floor 2.

It could be said that these lamps contribute only towards heating the inner space of the oven and not the walls thereof.

This oven, in one preferred embodiment, is provided with means 4 for controlling the power of the lamps.

These are connected to the lamps via any means known to the person skilled in the art (wire or other connection) and are referenced 40 in FIG. 1.

They particularly integrate computer means.

These control means also comprise at least one temperature sensor placed in the floor 2.

In the example illustrated here, there are two sensors 50 and 51 connected to the control means 4 via a connection referenced 500 and 501 respectively.

The sensor 50 is placed “level with” the upper surface of the floor, whilst the sensor 51 is placed “in the core”. In other words, the sensor 50 lies practically flush with the upper surface whilst the sensor 51 takes up an intermediate position (or optionally on the lower surface of the floor) in the direction of the thickness of the floor.

Thus distributed, the sensor 50 records the heat flow received by the surface of the floor, whilst the sensor 51 gives information on the in-depth temperature of the floor.

In addition, the means 4 when it is so desired are capable of modulating the power of the lamps 3. Therefore if it is desired to reduce the power of these lamps, these means are able to drive the lowering of the power of all the lamps.

However, to achieve this same objective and in a different embodiment, the means 4 are capable of causing the alternate switching-on and switching-off of a first part of the lamps 3, in synchronization with the switching-off and switching-on of a second part of these lamps.

Preferably the lamps of the first and second parts are judiciously distributed over the entire surface of the oven, so that “globally uniform radiation” of the floor is obtained, irrespective of the group of lamps which is switched on.

Also preferably, a system for measuring the power consumed by the lamps (such as an ammeter or wattmeter) is installed in the control box to detect whether a lamp has an operating anomaly and must be replaced.

Finally reference 6 denotes means for generating and controllably injecting steam into the chamber 10.

In the figure this steam is denoted V.

It will be noted that these means also comprise piping 60 for recovering non-absorbed steam inside the oven and for returning same towards said generating means 6.

As indicated above, the present invention also concerns a method for baking cereal-based food dough, in particular fermented bread dough.

At a first step, this method comprises heating the, empty, oven 1 using the heating means 3.

This is illustrated in appended FIG. 2 in which reference 30 schematically illustrates the radiation emitted by each of the lamps.

Preferably, this step is implemented at full power of the lamps, with a radiation wavelength of the order of 1 to 1.5 μm.

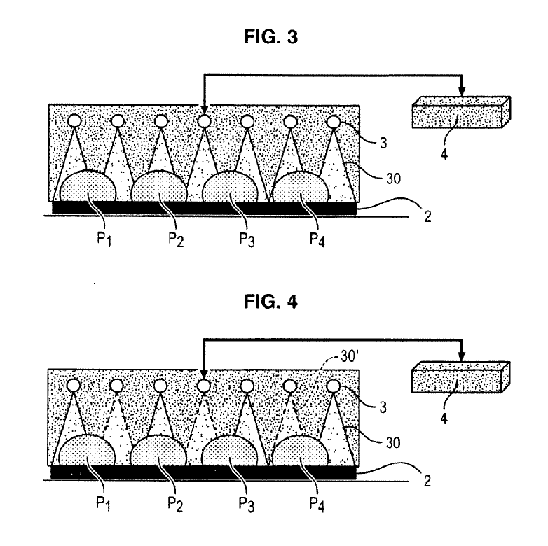

When the pre-heating temperature is reached, this information being provided by the aforementioned sensor 51 for example, the dough is placed in the oven preferably in the form of dough pieces P₁ to P₄ as shown in FIG. 3.

The power of all the lamps 3 can then be reduced during this baking phase of the dough pieces. By way of indication, the power of the lamps is then 10 to 20% of their nominal power. In some operating modes, the power of the lamps may also be reduced to 0% in particular for partial baking of the loaves for which it is not desired to obtain coloring of the crust.

In one alternative illustrated in FIG. 4, this reduction in power is obtained not by reducing the power of all the lamps 3 but by performing alternate switching-on and switching-off of part of the lamps 3 in synchronization with the switching-off and switching-on of a second part of the lamps. Therefore, preferably the number of lamps is even.

Conjointly with the previously described baking phase, steam can be injected continuously or selectively. Under standard conditions, steam is injected at the start of baking. However the injection can also be continued throughout baking, the objective being to delay coloring of the bread crust. This may also have the effect of reducing the quantity of neoformed compounds such as acrylamides (carcinogen substances).

Comparative tests were performed using two ovens of equivalent size and of same construction.

A (control) oven made by MIWE—Germany (MIWE-0011208) was used as base for comparison.

This control oven was equipped with individualized heating for the roof and for the floor, with a floor in refractory cement of thickness 20 mm (density 2200 kg/m³, specific heat 1.1 J/g/K, conductivity 1.03 W/m/K).

The inner dimensions of the oven were the following: Depth×width×height: 850×1240×240 mm. The volume of the oven was therefore 0.25 m³ with an effective baking surface of 1.05 m².

A prototype oven (IR oven) using the same base was developed using infrared lamps as sole heating mode.

For this oven, no electric supply or heating was installed in the lower part (floor). Twelve infrared lamps produced by HERAEUS (Heraeus—Germany reference 80047927 were positioned in the upper part of the oven (space between lamps: 60 mm; lamp diameter: 10 mm).

The nominal operating mode ensured a power of 2500 W per lamp. The nominal temperature of the filament was 1850 K corresponding to a power peak emitted at the wavelength of 1.5 μm.

The total available power was therefore about 30 kW for this IR oven whereas it was about 7.5 to 8 kW for the control oven. Here mention is only made of the power relating to the heating system and the regulating system, the power consumption of the latter being negligible. For the two ovens used, the same steam-producing system was used (about 3 kW).

A power regulator was used to control the power of the IR lamps.

The distance separating the lamps from the floor was about 200 mm.

The loaves used were obtained with the following recipe: type 55 flour (supplied by Moulins Soufflet Pantin-Pornic-ash content 0.53, protein content: 10.58% dry matter, falling number 402 s, Zeleny value 38, parameters as per Chopin alveograph: W=183, Pm/L=0.62).

For 100 g of flour, the recipe used 58 g of water, 3 g of yeast (supplied by Michard SS—Theix, France), 1.8 g of salt (supplied by Esco, Levallois Perret, France, S.A.) and 1 g of improver (supplied by PURATOS—Groot Bijgaarden—Belgium).

The dough was kneaded in a dough mixer (commercial reference SP10 spiral mixer—by VMI, Montaigu, France) for 3 min at a rotation speed of 100 rpm followed by 6 minutes at 200 rpm.

On completion of mixing, the temperature of the dough was 20 to 25° C.

The dough was left to stand for 10 minutes and then divided and shaped into pieces (70 g pieces) in a dough divider (by Bongard, Holtzheim, France).

The 70 g dough pieces were then placed on aluminium trays (weight 670 g, size 40 cm×80 cm). Twelve loaves were placed on each tray. The 70 g dough pieces were pierced with 5 holes using a needle to ensure suitable rising-fermentation.

Fermentation was carried out in a special chamber (by Panimatic, Souppes s/Loing, France) for 60 min, at a temperature of 30° C. and 95% relative humidity.

The expansion rate of the dough was about 3.6 relative to the initial volume of the dough.

The baking method of “prebaked bread” type (PP) was conducted at 200° C. For the first 30 seconds after placing in the oven, 100 ml steam was injected and then the set temperature was lowered to 170° C. for 16 min and 30 s for baking in the conventional oven.

The loaves thus obtained were baked but the crust was not colored. The loaves were cooled for 30 min at ambient temperature then frozen in a freezer (−30° C. for 35 min.) placed in a plastic bag and stored at −18° C.

For the second baking, the loaves were unfrozen for 10 min at ambient temperature. The second baking was conducted at 240° C. During the first 4 minutes of baking, steam (300 ml) was injected with the chimney closed then, during the 4 following minutes, the chimney was open (total baking time 8 min).

For the tests, a maximum occupancy rate was used with 3.4 kg of dough for an oven surface of 1 m² (48 loaves of initial weight 70 g).

The oven pre-heating phase was conducted for the control oven starting from a cold oven (20° C.) and waiting until the set temperature was reached.

For the “IR oven” pre-heating was conducted using only the IR lamps. Pre-heating was conducted starting from a cold oven (20° C.) and targeting a temperature of 200° C. to be reached in the floor. The IR lamps were used at full power. The temperature of the floor was measured with six thermocouples positioned at three different points along a central line in the oven.

One pair of thermocouples was arranged close to the door of the oven, another pair in the centre of the oven and a last pair at the bottom of the oven.

For each pair of thermocouples, one was positioned at about 1 mm underneath the upper side of the floor and another was placed in direct contact with the lower side of the floor.

The pre-heating phase lasted about 40 min and 9 min with the control oven and IR oven respectively. The baking time of the loaves was determined as being the time needed to reach 98° C. at the centre of a loaf, followed by a plateau of 10 min at this same temperature. This temperature corresponds to the maximum temperature reached by the crumb during conventional baking (plateau temperature).

The total baking time was 17 minutes.

For some tests, a flow sensor was placed in the lower part of the loaf in contact with the floor. The objective was to evaluate the quantity of heat transmitted by the floor during baking.

Two thermocouples of K type were used to measure the temperature of the crust and crumb throughout baking.

The loaves obtained were analyzed in terms of volume, crumb firmness, median diameter of the gas alveoli, crust-crumb ratio, moisture content and change in crust color (“total color difference”).

The results obtained given in Table 1 evidence that the two baking conditions (control oven for reference and IR oven) lead to the same result: the quality of the loaves was fully comparable irrespective of the oven used.

The electric power consumed by the ovens was also measured using a wattmeter of sensitivity 2 Wh (7.2 kJ). This wattmeter measured active power.

The specific energy (SE) in MJ per kg of dough was evaluated. For the pre-heating phase, the energy required for preheating the oven was measured starting from an oven at an initial temperature of 20° and up until the desired set temperature was reached. The results obtained are also given in Table 1.

TABLE 1
Experimental results for the first baking phase
of pre-baked bread
(SE = Specific energy in MJ per kg of dough)
(For baking, the power of the IR oven was 0%)

| | Oven used | |
|---|---|---|
| Parameters | “IR” oven | Control oven |
| Preheating time | 9/2450/680 | 40/5000/1340 |
| (min)/energy (Wh)/SE (Wh · kg⁻¹) | | |
| Baking time (min)/energy | 17/0/0 | 17/300/83 |
| (Wh)/SE (Wh · kg⁻¹) | | |
| Reheating time after baking | 2/500/140 | 7/760/211 |
| (min)/energy (Wh)/SE (Wh · kg⁻¹) | | |
| Specific volume of the loaves | 3.8 | 3.5 |
| (ml/g) | | |
| Crumb firmness (force after | 0.74 | 0.98 |
| compression of 20 mm slice to | | |
| 40% of its height-plunger | | |
| diameter 2 cm, adaptation | | |
| of AACC(N) protocol | | |
| Median diameter of | 0.78 | 0.78 |
| crumb gas cells(mm) | | |
| Crust/crumb ratio | 1.1 | 1.12 |
| (considering the weight ratio | | |
| of dry matter contained | | |
| in the crust and crumb) | | |
| Crust water content | 26.4 | 26 |
| (moisture basis) % | | |
| Crumb water content | 44.5 | 44 |
| (moisture basis)% | | |
| Total variation in crust color | 9 | 8 |
| Water loss during baking (%) | 13.5 | 14.5 |

Tests for the second baking of pre-baked bread were also conducted.

The protocol comprised heating the oven (initial temperature 25° C.) up to the set temperature of 240° C. For the IR oven the lamps were at their nominal power. The pre-heating time for the IR oven was 12 min. The prebaked loaves were then left to bake (second baking) in the “IR” oven, reducing the power of the lamps to 370 W which corresponds to a temperature of the filament of about 1400 K (emission peak at a wavelength of about 2.1 μm).

To obtain uniform coloring, the infrared lamps were switched on alternately. This alternation took place every 30 seconds.

This operating mode allowed uniform crust coloring to be obtained, irrespective of the position of the loaves in the oven.

The loaves obtained after second baking according to this operating mode were analyzed and compared with those obtained with the control oven (conventional baking). The results are given in Table 2 and show that the IR oven allows loaves of equivalent quality to be obtained.

TABLE 2
Experimental results for the second baking phase
of the prebaked loaves

| | Oven used | |
|---|---|---|
| Parameters | “IR” oven | Control oven |
| Preheating time (min)/energy | 12/3600/1000 | 50/6000/1670 |
| (Wh)/SE (Wh · kg⁻¹) | | |
| Baking time (min)/energy | 8/240/70 | 8/600/170 |
| (Wh)/SE (Wh · kg⁻¹) | | |
| Reheating time after baking | 3/650/180 | 6/500/140 |
| (min)/energy (Wh)/SE (Wh · kg⁻¹) | | |
| Specific volume of the loaves | 4.4 | 4.4 |
| (ml/g) | | |
| Crumb firmness (force after | 0.65 | 0.55 |
| compression of 20 mm slice to | | |
| 40% of its height-plunger | | |
| diameter 2 cm, adaptation of | | |
| AACC(N) protocol | | |
| Median diameter of | 0.8 | 0.33 |
| crumb gas cells (mm) | | |
| Crust/crumb ratio | 1.8 | 1.95 |
| (considering weight ratio | | |
| of dry matter contained | | |
| in the crust and crumb) | | |
| Crust water content | 20 | 19 |
| (moisture basis) % | | |
| Crumb water content | 42 | 44 |
| (moisture basis) % | | |
| Total variation in crust color | 23 | 20 |
| Water loss during baking (%) | 7 | 6 |

The curves in FIGS. 5, 6 and 7 allow a comparison between the different baking parameters for the IR oven subject of the present invention and the conventional control oven equipped with two heating systems

Measurements concerned the prebaking phase of the bread. The curves in these figures respectively give the measurements of heat flow, crust temperature and crumb temperature as a function of time. The curves in bold lines relate to the conventional control oven, whilst the thin line curves relate to the IR oven of the invention.

It is noted that the differences observed are not significant, and the conclusion can be drawn that there exists large similarity between the two oven designs with regard to the quality of the loaves obtained.

Tests to compare the influence of the pre-heating temperature of the “infrared” oven according to the invention were carried out. The control oven was considered with a pre-heating temperature of 230° C. and the “infrared” oven with a pre-heating temperature of the floor of 190° C., 210° C. and 230° C.

During the baking phase in the infrared oven, the power transmitted to the oven was zero.

For each baking, 36 loaves of 70 g (initial weight of the dough) were placed in the oven following an identical dough preparation method to the previous method. Two hundred milliliters of steam were injected into the oven at the start of baking. The total baking time was 18 minutes.

During these tests, energy consumption was not measured.

The volume of the loaves, crust/crumb ratio (weight ratio of dry matter) and the total color difference between the non-baked dough and the baked bread were measured.

Appended FIGS. 8, 9 and 10 give the results, in the form of rectangles, of the tests conducted with the oven of the invention with preheating of 190, 200 and 210° C. (from left to right) and with the control oven (preheating to 230° C.—on the right).

FIG. 8 gives the volume values of the loaves (in ml/g). FIG. 9 gives the crust/crumb ratio, whilst FIG. 10 gives the color difference dE.

It can be seen in the appended figures that the infrared oven appears to give a higher volume and crust/crumb ratio than the control oven whilst having a lower preheating temperature (230° C. in the conventional oven against 200° C. in the infrared oven).

The loaves baked in the infrared oven were a little less colored however than the loaves baked in the conventional oven: this is shown by the trend of the “delta E” parameter (total color difference as per the CIELAB-CIE Pub reference frame, 1986, Colorimetry, 2^{nd} Ed., CIE Central Bureau, Vienna).

On the basis of these tests, the following conclusions can be drawn:

1) The baking method subject of the invention (“IR oven”) allows loaves to be obtained whose main qualitative parameters (cf. Tables 1 and 2) can be considered to be identical to those of loaves prebaked and baked in a conventional oven.

2) The physical parameters such as the heat flow received by the base of the loaf and the trend in temperature of the crust and crumb are practically identical,

3) The specific energy consumed by the oven of the invention is 49% lower than for the conventional oven during the pre-heating phase, for a method of prebaked bread type (680 Wh/kg against 1340 Wh/kg—cf. Table 1). The pre-heating time was reduced by 77% (9 minutes against 40 minutes—cf. Table 1).

4) The specific energy for the baking phase (under conditions of “prebaking” type) was reduced by 100% for the IR oven (0 against 83—cf. Table 1). This is due to the fact that the power was at 0% during the IR baking phase through use of the energy stored in the floor.

5) The specific energy for the reheating phase after baking (under conditions of “prebaking” type) was reduced by 33% for the IR oven (140 against 211—cf. Table 1).

The specific energy consumed by the oven of the invention was 40% lower than for the conventional oven during the pre-heating phase for a method of final baking type of a prebaked loaf (1000 Wh/kg against 1670 Wh/kg—cf. Table 2). The pre-heating time was reduced by 76% (12 minutes against 50 minutes—cf. Table 2).

6) The specific energy for the baking phase (under conditions of final baking type of a prebaked loaf) was reduced by 59% for the oven of the invention (70 against 170—cf. Table 2).

7) The specific energy for the reheating phase after baking (under conditions of final baking type of a prebaked loaf) was increased by 29% for the oven of the invention (180 against 140—cf. Table 2).

8) The oven of the invention, under some conditions, allows a higher volume and crust/crumb weight ratio to be reached with a lower pre-heating temperature compared with the control, conventional oven.

It can be concluded from these tests, that the proposed oven and method offer a reduction in energy requirement of about 40 to 50% compared with a conventional baking technique.

This improvement can be attributed to the rapidity of heating with the infrared system, which limits losses to surroundings via the insulation. It is recalled here that the two ovens used had the same base, the same structure and the same thermal insulation.

1.-21. (canceled)

22. A baking oven for food use for baking a cereal-based dough, in particular a fermented dough, which comprises a thermally insulated chamber whose base is formed of a floor in refractory material and which contains heating means for heating the floor and said chamber,
wherein said heating means are formed of means emitting energy mostly in the form of electromagnetic radiation in an infrared region, arranged in the upper part of the chamber and oriented in the direction of the floor; and in that it is devoid of any other means for heating said floor.

23. The oven according to claim 22, wherein by the fact that said heating means are formed of lamps.

24. The oven according to claim 22, wherein it comprises control means for controlling the power of said heating means.

25. The oven according to claim 23, wherein it comprises control means for controlling the power of said heating means.

26. The oven according to claim 24, wherein said power controlling means comprise at least one temperature sensor placed in said floor.

27. The oven according to claim 26, which comprises at least two sensors wherein these sensors, considering the thickness of said floor, each occupy a different position relative to the upper surface thereof.

28. The oven according to claim 22, wherein it comprises means for modulating the power of the heating means, such as temperature sensors or heat flow sensors.

29. The oven according to claim 28, wherein said means are capable of reducing and respectively increasing the power of all the heating means.

30. The oven according to claim 28, wherein said means, in order to reduce the power of the heating means, are capable of causing the alternate switching-on/switching-off of a first part of these means synchronized with the switching-off/switching-on of a second part of these means.

31. The oven according to claim 22, wherein, at full power, said heating means emit radiation of wavelength in the short infrared range (0.8 to 2 μm) or mid-infrared (2 to 4 μm).

32. The oven according to claim 22, wherein the floor is of dark color capable of promoting absorption of the infrared radiation close to the wavelength of the visible range (short infrared).

33. The oven according to claim 22, wherein it comprises means for generating steam (V) and for the controlled injection thereof into said chamber, and optionally for recovering the non-absorbed steam.

34. A method for baking a cereal-based food dough, in particular a fermented dough, in an oven which comprises a thermally insulated chamber whose base is formed of a floor in refractory material and which contains means for heating the floor and said chamber, which consist of a set of heating means such as lamps emitting in the infrared, arranged in the upper part of the chamber and oriented in the direction of the floor to the exclusion of any other means for heating said floor,
wherein it comprises the implementation of the following steps:
a/ pre-heating the, empty oven using said heating means;
b/ placing said dough in this oven leaving it to rest on the floor;
c/ reducing or zeroing the power of said heating means and continuing baking until the desired degree and/or time of baking are obtained;
d/ during the baking phase, optionally adding a certain amount of steam to promote expansion of the bread during baking (expansion of the fermented dough in the oven).

35. The method according to claim 34, wherein that the desired baking time is measured using the measurement given by a temperature probe arranged in the dough or in the floor, or given by thermometric means remotely measuring the temperature of the surface of the dough during baking via infrared radiation.

36. The method according to claim 34, wherein the pre-heating time of the oven is measured using the measurement given by a temperature probe arranged in the floor, by thermometric means remotely communicating via infrared radiation and allowing remote measurement of the temperature of the upper or lower side of the floor, or by a flow meter installed in the floor.

37. The method according to claim 34 wherein at step c/, the power of all the heating means is reduced.

38. The method according to claim 34, wherein at step c/ alternate switching-on/switching-off is caused of the heating means in synchronization with the switching-off/switching-on of a second part of the heating means.

39. The method according to claim 34, wherein the completion of baking is controlled by video means capable of assessing the extent of coloring of the crust of the dough pieces, to act on the power of said heating means and decide on completion of baking.

40. The method according to claim 34, wherein the ratio between the energy returned by the floor during baking and the energy required for baking the dough pieces is between about 2 and 3.

41. The oven according to claim 22, wherein it is equipped with a system for measuring the electric power consumed by each lamp individually, to detect whether a lamp has an operating anomaly and must be replaced.

42. The oven according to claim 22, wherein the electric connections of said lamps lie outside the chamber.

43. The oven according to claim 22, wherein said heating means consist of burners equipped with a metal foam or refractory ceramic and supplied with gas fuel such as natural gas or liquid petroleum gas.
